(19) United States
(12) Patent Application Publication
(10) Pub. No.: US 2009/0074953 A1
(43) Pub. Date: Mar. 19, 2009

(54) Lithium cell cathode

(76) Inventors: Sean Chang, Cheshire, CT (US); Michael Pozin, Brookfield, CT (US)

Correspondence Address: MR. BARRY D. JOSEPHS;ATTORNEY AT LAW, 19 NORTH STREET, SALEM, MA, 01970, US

(21) Appl. No.: 11/901,214

(22) Filed: Sep. 14, 2007

(51) Int. Cl. B05D 5/12; H01M 6/00

(52) U.S. Cl. 427/74

(57) ABSTRACT

A primary cell having an anode comprising lithium and a cathode comprising iron disulfide (FeS₂) and carbon particles. The electrolyte comprises a lithium salt dissolved in a solvent mixture. A cathode slurry is prepared comprising iron disulfide powder, carbon, binder, and a liquid solvent. The mixture is coated onto a substrate and solvent evaporated leaving a dry cathode coating on the substrate. The cathode coating is then baked at elevated temperatures in atmosphere under partial vacuum or in an atmosphere of nitrogen or inert gas. The anode and cathode can be spirally wound with separator therebetween and inserted into the cell casing with electrolyte then added.

### FIELD OF THE INVENTION

The invention relates to a method of preparing a cathode for a lithium primary cell having an anode comprising lithium metal or lithium alloy and a cathode comprising iron disulfide and an electrolyte comprising a lithium salt and solvents.

### BACKGROUND

Primary (non-rechargeable) electrochemical cells having an anode of lithium are known and are in widespread commercial use. The anode is comprised essentially of lithium metal. Such cells typically have a cathode comprising manganese dioxide, and electrolyte comprising a lithium salt such as lithium trifluoromethane sulfonate (LiCF₃SO₃) dissolved in a nonaqueous solvent. The cells are referenced in the art as primary lithium cells (primary Li/MnO₂ cells) and are generally not intended to be rechargeable. Alternative primary lithium cells with lithium metal anodes but having different cathodes, are also known. Such cells, for example, have cathodes comprising iron disulfide (FeS₂) and are designated Li/FeS₂ cells. The iron disulfide (FeS₂) is also known as pyrite. The Li/MnO₂ cells or Li/FeS₂ cells are typically in the form of cylindrical cells, typically an AA size cell or AAA size cells, but may be in other size cylindrical cells. The Li/MnO₂ cells have a voltage of about 3.0 volts which is twice that of conventional Zn/MnO₂ alkaline cells and also have higher energy density (watt-hrs per cm³ of cell volume) than that of alkaline cells. The Li/FeS₂ cells have a voltage (fresh) of between about 1.2 and 1.8 volts which is about the same as a conventional Zn/MnO₂ alkaline cell. However, the energy density (watt-hrs per cm³ of cell volume) of the Li/FeS₂ cell is higher than a comparable size Zn/MnO₂ alkaline cell. The theoretical specific capacity of lithium metal is high at 3861.7 mAmp-hr/gram and the theoretical specific capacity of FeS₂ is 893.6 mAmp-hr/gram. The FeS₂ theoretical capacity is based on a 4 electron transfer from 4Li per FeS₂ molecule to result in reaction product of elemental iron Fe and 2Li₂S. That is, 2 of the 4 electrons change the oxidation state (valence) of +2 for Fe⁺² in FeS₂ to 0 in elemental iron, Fe⁰ and the remaining 2 electrons change the oxidation state of sulfur from −1 in FeS₂ to −2 in Li₂S. In order to carry out the electrochemical reaction the lithium ions, Li⁺, produced at the anode must transport through the separator and electrolyte medium and to the cathode.

Overall the Li/FeS₂ cell is much more powerful than the same size Zn/MnO₂ alkaline cell. That is for a given continuous current drain, particularly for higher current drain over 200 milliAmp, in the voltage vs. time profile the voltage drops off much less quickly for the Li/FeS₂ cell than the Zn/MnO₂ alkaline cell. This results in a higher energy output obtainable from a Li/FeS₂ cell compared to that obtainable for a same size alkaline cell. The higher energy output of the Li/FeS₂ cell is also clearly shown more directly in graphical plots of energy (Watt-hrs) versus continuous discharge at constant power (Watts) wherein fresh cells are discharged to completion at fixed continuous power outputs ranging from as little as 0.01 Watt to 5 Watt. In such tests the power drain is maintained at a constant continuous power output selected between 0.01 Watt and 5 Watt. (As the cell's voltage drops during discharge the load resistance is gradually decreased raising the current drain to maintain a fixed constant power output.) The graphical plot Energy (Watt-Hrs) versus Power Output (Watt) for the Li/FeS₂ cell is above that for the same size alkaline cell. This is despite that the starting voltage of both cells (fresh) is about the same, namely, between about 1.2 and 1.8 volt.

Thus, the Li/FeS₂ cell has the advantage over same size alkaline cells, for example, AAA, AA, C or D size or any other size cell in that the Li/FeS₂ cell may be used interchangeably with the conventional Zn/MnO₂ alkaline cell and will have greater service life, particularly for higher power demands. Similarly the Li/FeS₂ cell which is primary (nonrechargeable) cell can be used as a replacement for the same size rechargeable nickel metal hydride cells, which have about the same voltage (fresh) as the Li/FeS₂ cell.

The Li/MnO₂ cell and Li/FeS₂ cell both require non aqueous electrolytes, since the lithium anode is highly reactive with water. One of the difficulties associated with the manufacture of a Li/FeS₂ cell is the need to add good binding material to the cathode formulation to bind the Li/FeS₂ and carbon particles together in the cathode. The binding material must also be sufficiently adhesive to cause the cathode coating to adhere uniformly and strongly to the metal conductive substrate to which it is applied.

The cathode material may be initially prepared in a form such as a slurry mixture, which can be readily coated onto the metal substrate by conventional coating methods. The electrolyte added to the cell must be a suitable nonaqueous electrolyte for the Li/FeS₂ system allowing the necessary electrochemical reactions to occur efficiently over the range of high power output desired. The electrolyte must exhibit good ionic conductivity and also be sufficiently stable, that is non reactive, with the undischarged or partially discharged electrode materials (anode and cathode components) and also non reactive with the discharge products. This is because undesirable oxidation/reduction reactions between the electrolyte and electrode materials (either discharged or undischarged or partially discharged) could thereby gradually contaminate the electrolyte and reduce its effectiveness or result in excessive gassing. This in turn can result in a cell failure. Thus, the electrolyte used in Li/FeS₂ cell in addition to promoting the necessary electrochemical reactions, should also be stable to discharged, partially discharged and undischarged electrode materials. Additionally, the electrolyte should enable good ionic mobility and transport of the lithium ion (Li⁺) from anode to cathode so that it can engage in the necessary reduction reaction resulting in Li₂S product in the cathode.

Primary lithium cells are in use as a power source for digital flash cameras, which require operation at higher pulsed power demands than is supplied by individual alkaline cells. Primary lithium cells are conventionally formed of an electrode composite comprising an anode formed of a sheet of lithium (or lithium alloy, essentially of lithium), a cathode formed of a coating of cathode active material comprising FeS₂ on a conductive metal substrate (cathode substrate) and a sheet of electrolyte permeable separator material therebetween. The electrode composite may be spirally wound and inserted into the cell casing, for examples, as shown in U.S. Pat. No. 4,707,421.

A cathode coating mixture for the Li/FeS₂ cell is described in U.S. Pat. No. 6,849,360 B2 and U.S. Pat. No. 7,157,185 B2. The cathode described in these two references includes FeS₂ particles, carbon particles (acetylene black and graphite), fumed silica, and a polymer binder preferably a styrene-ethylene/butylene-styrene (SEBS) block copolymer. Such binder is described as available as Kraton G1651 from Kraton Polymers, Houston Tex. These latter references describe that the cathode components are first made into a wet cathode slurry by adding solvent such as 1,1,2-trichloroethylene. The wet slurry is then applied to both sides of a carrier sheet, namely, a continuous aluminum strip, to form the wet cathode. It is implied that the wet cathode is then dried, since the phrase “after drying” appears (U.S. Pat. No. 6,849,360 at col. 6, line 3 and U.S. Pat. No. 7,157,185 at col. 6, line 33). There is no discussion in these two references of any specific manner in which the drying of the wet cathode is carried out. The references do not mention, nor are they concerned with, any particular drying method, drying atmosphere, or heating sequence and temperatures required to carry out the drying of the wet cathode. In fact there is no indication that any particular method of drying of the wet cathode or subsequent heat treatment of the dried cathode would be desirable or lead to better results.

A portion of the spiral wound anode sheet is typically electrically connected to the cell casing which forms the cell's negative terminal. The cell is closed with an end cap which is insulated from the casing. The cathode sheet can be electrically connected to the end cap which forms the cell's positive terminal. The casing is typically crimped over the peripheral edge of the end cap to seal the casing's open end. The cell may be fitted internally with a PTC (positive thermal coefficient) device or the like to shut down the cell in case the cell is exposed to abusive conditions such as short circuit discharge or overheating.

The anode in a Li/FeS₂ cell can be formed by laminating a layer of lithium metal on a metallic substrate such as copper. However, the anode may be formed of a sheet of lithium without any substrate.

The electrolyte used in a primary Li/FeS₂ cells are formed of a “lithium salt” dissolved in an “organic solvent”. The electrolyte must promote ionization of the lithium salt and provide for good ionic mobility of the lithium ions so that the lithium ions may pass at good transport rate from anode to cathode through the separator. Representative lithium salts which may be used in electrolytes for Li/FeS₂ primary cells are referenced in U.S. Pat. Nos. 5,290,414 and U.S. Pat. No. 6,849,360 B2 and include such salts as: Lithium trifluoromethanesulfonate, LiCF₃SO₃ (LiTFS); lithium bistrifluoromethylsulfonyl imide, Li(CF₃SO₂)₂N (LiTFSI); lithium iodide, LiI; lithium bromide, LiBr; lithium tetrafluoroborate, LiBF₄; lithium hexafluorophosphate, LiPF₆; lithium hexafluoroarsenate, LiAsF₆; Li(CF₃SO₂)₃C; LiClO₄; lithium bis(oxalato)borate, LiBOB and various mixtures. In the art of Li/FeS₂ electrochemistry lithium salts are not always interchangeable as specific salts work best with specific electrolyte solvent mixtures.

In U.S. Pat. No. 5,290,414 (Marple) is reported use of a beneficial electrolyte for FeS₂ cells, wherein the electrolyte comprises a lithium salt dissolved in a solvent comprising 1,3-dioxolane in admixture with a second solvent which is an acyclic (non cyclic) ether based solvent. The acyclic (non cyclic) ether based solvent as referenced may be dimethoxyethane (DME), ethyl glyme, diglyme and triglyme, with the preferred being 1,2-dimetoxyethane (DME). As given in the example the 1,2-dimethoxyethane (DME) is present in the electrolyte in substantial amount, i.e., at either 40 or 75 vol. % (col. 7, lines 47-54). A specific lithium salt ionizable in such solvent mixture(s), as given in the example, is lithium trifluoromethane sulfonate, LiCF₃SO₃. Another lithium salt, namely lithium bistrifluoromethylsulfonyl imide, Li(CF₃SO₂)₂N also mentioned at col. 7, line 18-19. The reference teaches that a third solvent may optionally be added selected from 3,5-dimethlyisoxazole (DMI), 3-methyl-2-oxazolidone, propylene carbonate (PC), ethylene carbonate (EC), butylene carbonate (BC), tetrahydrofuran (THF), diethyl carbonate (DEC), ethylene glycol sulfite (EGS), dioxane, dimethyl sulfate (DMS), and sulfolane (claim 19) with the preferred being 3,5-dimethylisoxazole.

In U.S. Pat. No. 6,849,360 B2 (Marple) is disclosed a specific preferred electrolyte for an Li/FeS₂ cell, wherein the electrolyte comprises the salt lithium iodide dissolved in the organic solvent mixture comprising 1,3-dioxolane (DX), 1,2-dimethoxyethane (DME), and small amount of 3,5 dimethylisoxazole (DMI). (col. 6, lines 44-48.) The electrolyte is typically added to the cell after the dry anode/cathode spiral with separator therebetween is inserted into the cell casing.

Contaminants can be introduced into the cell, from different sources, in particular, from the storage of FeS₂ powder prior to its use in the cathode mix. The stored FeS₂ powder as well as cathodes based on FeS₂ can gradually react with atmospheric air and moisture resulting in acidic and other byproducts, some capable of forming dendrites, which can all reduce cell life and can interfere with attainment of good cell performance during normal usage. Cathodes comprising FeS₂ may be mixed with carbon particles and organic solvents to produce a wet slurry which can be coated onto a substrate. It has been determined by Applicants herein that the method of drying the wet cathode can be important. Applicants have determined that an improved method of drying the wet cathode slurry coated on the metal carrier sheet, can result in a significant reduction of contaminants which would otherwise remain imbedded in the cathode and interfere with cell performance after the anode/cathode spiral is inserted into the cell and electrolyte added.

Accordingly, it is desired to improve the method of forming the cathode for the Li/FeS₂ cell, in particular to reduce the amount of contaminants carried into the cell by the FeS₂ powder.

In particular it is desired to subject the wet cathode slurry coated on a metal carrier sheet to an improved method of drying and treatment which includes baking at elevated temperature in selective atmospheres before the anode/cathode spiral is formed and electrolyte added to the cell.

It is desired that the improved method of treatment of the cathode for a Li/FeS₂ cell results in reduction of contaminants in the cathode regardless of the electrolyte which is thereafter added.

It is desired that the method of treatment be such that reduces the chance of the contaminants reoccurring.

It is desired to produce a primary (nonrechargeable) Li/FeS₂ cell having good rate capability that the cell may be used in place of rechargeable batteries to power digital cameras.

### SUMMARY OF THE INVENTION

The invention is directed to lithium primary cells wherein the anode comprises lithium metal. The lithium metal may be alloyed with small amounts of other metal, for example aluminum, or calcium which typically comprises less than about 1 or 2 wt. %, and even up to about 5 wt. % of the lithium alloy. Thus, the term “lithium” or “lithium metal” as used herein shall be understood to include such lithium alloy. The lithium which forms the anode active material, is preferably in the form of a thin foil. The cell has a cathode comprising the cathode active material iron disulfide (FeS₂), commonly known as “pyrite”. Desirably the cell may be cylindrical, comprising a spirally wound electrode assembly therein. The electrode assembly is formed of an anode sheet and a cathode composite sheet spirally wound with separator therebetween. The cathode composite sheet is formed by coating a cathode slurry mixture comprising iron disulfide (FeS₂) particles onto a conductive metal substrate. The cathode slurry coating on the conductive substrate is then predried to evaporate the solvents therein to form a dry cathode composite sheet (dried cathode coating on the substrate), which is calendered to compact the coating. The calendered cathode composite is then subjected to baking in accordance with the invention. The electrode spiral comprising anode sheet, baked cathode composite sheet with separator therebetween is formed and inserted into the cell casing and electrolyte then added.

The cathode is formed of a cathode slurry comprising iron disulfide (FeS₂) powder, conductive carbon particles, binder material, and solvent. (The term “slurry” as used herein will have its ordinary dictionary meaning and thus be understood to mean a wet mixture comprising solid particles.) The FeS₂ particles are bound to the conductive substrate using a polymeric binder, desirably an elastomeric polymeric binder, preferably, a styrene-ethylene/butylene-styrene (SEBS) block copolymer such as Kraton G1651 elastomer (Kraton Polymers, Houston, Tex.). This polymer is a film-former, and possesses good affinity and cohesive properties for the FeS₂ particles as well as for conductive carbon particle additives in the cathode mixture. The polymer is stable and nonreactive with the electrolyte and cell components. The wet cathode slurry is coated onto a conductive substrate such as a sheet of aluminum or stainless steel forming a cathode composite sheet. The conductive substrate functions as a cathode current collector. The solvent is then evaporated leaving a dry cathode coating comprising the iron disulfide material, carbon particles, and binder material, adhesively bound to each other within the dry cathode coating on the conductive substrate. The carbon particles provide a network of electrical pathways connecting the iron disulfide particles. The carbon particles preferably comprise carbon black. The preferred carbon black is acetylene black. The carbon may optionally include graphite particles blended therein.

A principal aspect of the invention is directed to an improved method for forming the cathode composite, that is, the cathode coating comprising iron disulfide (FeS₂), carbon, and binder material coated onto a conductive substrate. The method of the invention has the advantage of significantly reducing, if not eliminating, the amount of contaminants that may be present in the iron disulfide (FeS2) particles and cathode coating on the conductive substrate, prior to forming the wound electrode assembly for insertion into the cell casing.

The iron disulfide is purchased in the form of a powder. It has exposure to atmospheric air and moisture during transit and storage. This results in contaminants, which include mostly acids and Fe containing salts, forming on the surfaces and within the pores of the FeS₂ particles. The contaminants include acids and Fe containing salts such as FeS, H₂S, H₂SO₄, H₂SO₃, FeSO₄, FeSO₄.nH₂O (hydrate). If these contaminants are present in the cathode, they can react directly with electrolyte or cell components to significantly interfere with proper performance of the cell. It has been determined that if the FeS₂ particles are heat treated in a nitrogen atmosphere prior to their use in the cathode mixture, the level of contaminants can be reduced. But it has been found that the contaminants can gradually reform and reappear on the FeS₂ surfaces when the heat treated particles are subsequently placed in storage with exposure to atmospheric air and moisture. In a cell assembly operation it is not practical to heat treat the FeS₂ particles and use the heat treated FeS₂ particles immediately in forming the cathode slurry without exposing them to atmospheric air and moisture prior to forming the slurry.

In accordance with the method of the invention a solution to this problem has been developed so that there is no longer a need to preheat the FeS₂ powder to remove contaminants therein prior to forming the wet cathode slurry. When prepared by the method of the invention, the cathode comprising FeS₂ particles has the contaminant content substantially reduced at the time the cathode is inserted into the cell casing. The electrolyte, which is nonaqueous, is added to the cell as soon as possible after the cathode is inserted into the cell. The electrolyte prevents exposure of the FeS₂ particles to air and moisture, in turn preventing formation of the contaminants on the FeS₂ surface.

In the method of the invention the FeS₂ particles do not have to be pretreated by subjecting them to preheating in order to remove contaminants prior to formation of the wet cathode slurry. However, such pretreatment of the FeS₂ may optionally be included. The cathode may be formed by the method of the invention as follows:

a) forming a cathode slurry comprising FeS₂ particles (FeS₂ powder from supplier), carbon particles, binder, and solvent; b) applying the cathode slurry to a side of a conductive substrate; c) drying the cathode slurry, for example, in a convective air oven or the like, to form a dry cathode coating on the substrate; d) optionally, applying the cathode slurry also to the opposite side of the conductive substrate and if so then step (c) is repeated; and e) calendering the dried cathode coating to compress its thickness on the substrate. Applicant has determined if the dried cathode coating is then subjected to the additional step of f) baking the dried cathode coating on the conductive substrate in a partial vacuum air pressure, to reduce contaminants content, and the contaminants may be removed from the FeS₂ particles within the dried cathode coating. (The term partial vacuum pressure as used herein shall be understood to mean below atmospheric pressure.) Alternatively, the atmosphere in the baking step (f) may be an atmosphere of nitrogen (not limited to pressure) or an inert atmosphere of helium, argon, neon, or krypton. If the atmosphere is air, then it is desirable that the pressure be a partial vacuum, namely, air pressure less than about 80 mm Hg (absolute), preferably at pressure less than about 50 mm Hg (absolute). The cathode coating on the conductive substrate is desirably baked in step (f) in any of the above indicated atmospheres at elevated temperatures between about 250° C. and 375° C., preferably between about 290° C. and 350° C. for a period between about 2 and 24 hours. Such baking may be extended for up to about 3 to 4 days. In order for the contaminants not to substantially reoccur the cathode coating on the substrate is baked in step (f) forming a baked cathode. This is followed in a short time (after the baked cathode has cooled) by forming the wound electrode assembly (which includes the baked cathode, anode sheet and separator therebetween) and inserting the electrode assembly into the cell casing. Electrolyte is then added to the cell as soon as possible thereafter, preferably in less than about 24 hours. The baked cathode or wound electrode assembly can be stored for a period in sealed foil bags with nitrogen or other inert gas therein or in air or other atmosphere under partial vacuum conditions prior to insertion into the cell casing. Alternatively, the wound electrode assembly prior to or after insertion into the cell casing, may be stored in a dry room atmosphere having low relative humidity for a period up to about 24 hours. Electrolyte is then added to the cell covering the cathode with electrolyte.

It has been determined that baking of the cathode coating on the conductive substrate in the above indicated atmospheres allows use of the above elevated baking temperatures without causing deterioration in the physiochemical properties of the Kraton binder. These higher baking temperatures (between 250° C. and 375° C., preferably between about 290° C. and 350° C.) are preferred, since they result in easier removal of the contaminants from the FeS₂ particles within the cathode coating.

Although a preferred, representative electrolyte is given herein by way of example for the Li/FeS₂ cell, the advantage of the method of the invention for preparation of the FeS₂ cathode is not intended to be limited by any particular electrolyte for the Li/FeS₂ cell. The method of the invention for preparation of the FeS₂ cathode is thus generally believed to be useful and have advantage independent of the electrolyte employed in the cell.

### BRIEF DESCRIPTION OF THE DRAWINGS

FIG. 1 is an isometric view of an improved Li/FeS₂ cell of the invention as presented in a cylindrical cell embodiment.

FIG. 2 is a partial cross sectional elevation view of the cell taken through sight lines 2-2 of FIG. 1 to show the top and interior portion of the cell.

FIG. 3 is a partial cross sectional elevation view of the cell taken through sight lines 2-2 of FIG. 1 to show a spirally wound electrode assembly.

FIG. 4 is a schematic showing the placement of the layers comprising the electrode assembly.

FIG. 5 is a plan view of the electrode assembly of FIG. 4 with each of the layers thereof partially peeled away to show the underlying layer.

### DETAILED DESCRIPTION

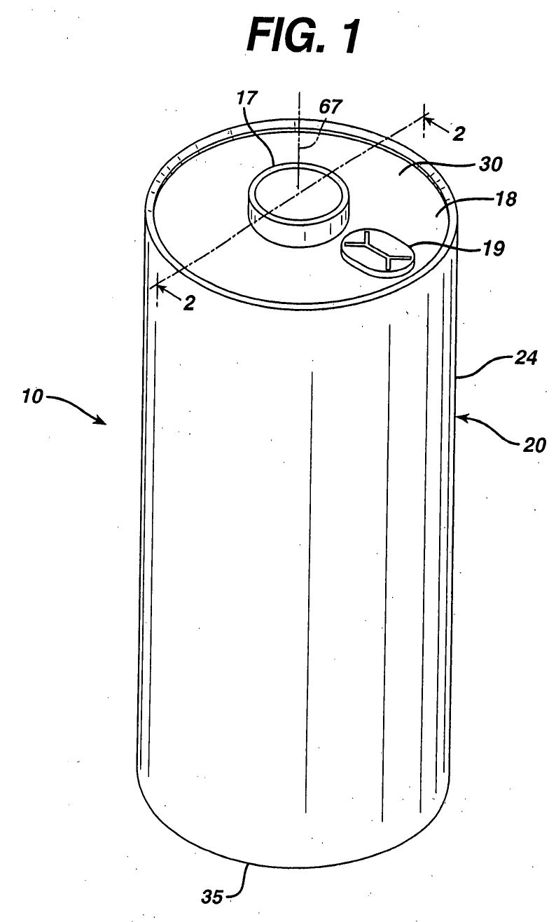

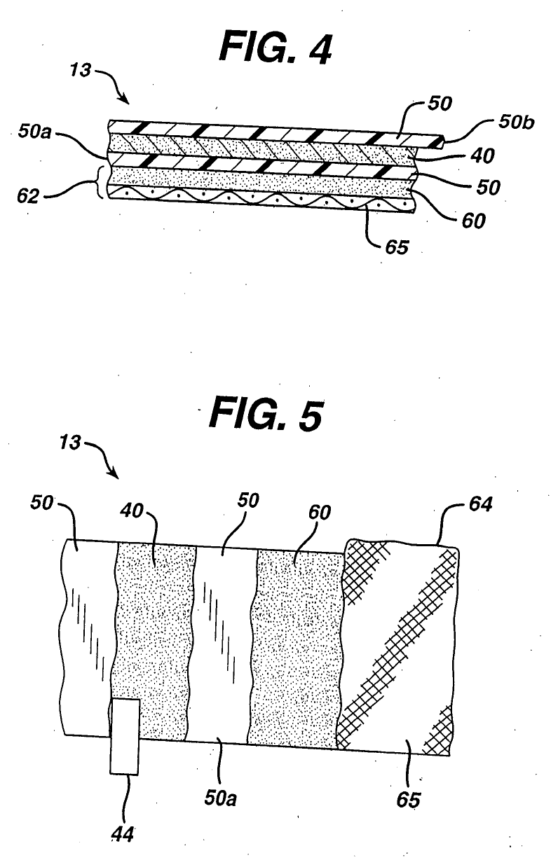

The Li/FeS₂ cell of the invention is desirably in the form of a spirally wound cell as shown in FIGS. 1-5. A desirable wound cell 10 configuration comprising a lithium anode 40 and a cathode composite 62 comprising iron disulfide (FeS₂) with separator sheet 50 therebetween is shown in the figures. The anode may comprise a sheet of lithium or lithium alloy 40. The cathode composite may comprise a coating of cathode material 60 comprising iron disulfide (FeS₂) which is coated on at least one side of a substrate 65 as shown best in FIGS. 4 and 5. The cathode material 60 may also be coated on both sides of substrate 65. The substrate or grid 65 is preferably an electrically conductive substrate, such as a sheet of aluminum, or stainless steel foil. The conductive substrate 65 may be a continuous solid sheet without apertures or may be a sheet with apertures therein, for example, formed from expanded stainless steel foil or expanded aluminum foil.

The anode 40 can be prepared from a solid sheet of lithium metal. The anode 40 is desirably formed of a continuous sheet of lithium metal (99.8% pure). Alternatively, the anode 40 can be an alloy of lithium and an alloy metal, for example, an alloy of lithium and aluminum or lithium and calcium. In such case the alloy metal, is present in very small quantity, preferably less than 1 or 2 percent by weight of the lithium alloy. Upon cell discharge the lithium in the alloy thus functions electrochemically as pure lithium. Thus, the term “lithium or lithium metal” as used herein and in the claims is intended to include in its meaning such lithium alloy. The lithium sheet forming anode 40 does not require a substrate. The lithium anode 40 can be advantageously formed from an extruded sheet of lithium metal having a thickness of desirably between about 0.10 and 0.20 mm desirably between about 0.12 and 0.19 mm, preferably about 0.15 mm for the spirally wound cell.

The Li/FeS₂ cell as in cell 100 has the following basic discharge reactions (one step mechanism):

Anode:

4Li=4Li⁺+4e Eq. 1

Cathode:

FeS₂+4Li⁺+4e=Fe+2Li₂S Eq. 2

Overall:

FeS₂+4Li=Fe+2Li₂S Eq. 3

The Li/FeS₂ cylindrical cell 10 may be in the form of a primary (nonrechargeable) cell.

The cathode material 60 of the invention comprising iron disulfide (FeS₂) or any mixture including iron disulfide (FeS₂) as active cathode material, may thus be coated onto one or both sides of conductive substrate 65 to form cathode composite sheet 62. The cathode active material, that is, the material undergoing useful electrochemical reaction, in cathode 60 can be composed entirely of iron disulfide (FeS₂). The cathode 60 comprising iron disulfide (FeS₂) powder dispersed therein can be prepared in the form of a wet slurry comprising a mixture of iron disulfide powder, carbon particles, polymeric binder and solvents mixed therein. The wet slurry is coated on one side of the conductive metal foil 65, preferably an aluminum or stainless steel foil as above indicated. The wet coating 60 on substrate 65 may then be dried in a conventional convective air oven to evaporate the solvents. Then a coating of the wet slurry may optionally also be applied to the opposite side (not shown) of conductive substrate 65. In such case the wet coating on the opposite side of conductive substrate 65 is similarly dried in a convective air oven to evaporate solvents. A cathode composite sheet 62 is formed with dry cathode coating 60 on one or both sides of conductive substrate 65. The cathode composite sheet 62 can then be subjected to calendering resulting a compacted smooth dry cathode coating 60 on conductive substrate 65.

The cathode slurry comprises 2 to 4 wt % of binder (Kraton G1651 elastomeric binder from Kraton Polymers, Houston Tex.); 50 to 70 wt % of active FeS₂ powder; 4 to 7 wt % of conductive carbon (carbon black and graphite); and 25 to 40 wt % of solvent(s). (The carbon black may include in whole or in part acetylene black carbon particles. Thus, the term carbon black as used herein shall be understood to extend to and include acetylene black carbon particles.) The Kraton G1651 binder is a polymeric elastomeric block copolymer (styrene-ethylene/butylene (SEBS) block copolymer) which is a film-former. The Kraton polymeric binder is soluble in the solvents employed in forming the wet cathode slurry. Kraton binder has excellent film forming properties and readily disperses over the iron disulfide particles and conductive carbon particles to help keep these particles in contact with each other. That is, the binder possesses sufficient affinity for the active FeS₂ and carbon black particles to facilitate preparation of the wet cathode slurry and to keep these particles in contact with each other in a network after the solvents are evaporated. The Kraton binder is also stable in the electrolyte which is subsequently added to cell after the anode 40, cathode 62 with separator 50 therebetween are wound and inserted into the cell casing. The Kraton binder is chemically and electrochemically resistant so that it does not react with the electrolyte or other cell contents during cell storage or discharge, even over a wide range of environmental conditions between about −10° C. and 60° C.

The FeS₂ powder may have an average particle size between about 1 and 100 micron, desirably between about 10 and 50 micron. A desirable FeS₂ powder is available under the trade designation Pyrox Red 325 powder from Chemetall GmbH, wherein the FeS₂ powder has a particle size sufficiently small that of particles will pass through a sieve of Tyler mesh size 325 (sieve openings of 0.045 mm). (The residue amount of FeS₂ particles not passing through the 325 mesh sieve is 10% max.) The graphite is available under the trade designation Timrex KS6 graphite from Timcal Ltd. Timrex graphite is a highly crystalline synthetic graphite. (Other graphites may be employed selected from natural, synthetic, or expanded graphite and mixtures thereof, but the Timrex graphite is preferred because of its high purity.) The carbon black is available under the trade designation Super P conductive carbon black and is an acetylene black (BET surface of 62 m²/g) from Timcal Co.

Solvents are mixed into the FeS₂ powder, carbon particles, and polymeric binder to form a wet cathode slurry. (In a preferred mixing sequence solvents are mixed first with binder to form a binder/solvent mixture. FeS₂ and carbon particles are separately mixed and then added to the binder/solvent mixture.) The solvents preferably include a mixture of C₉-C₁₁ (predominately C₉₎aromatic hydrocarbons available as ShellSol A100 hydrocarbon solvent (Shell Chemical Co.) and a mixture of primarily isoparaffins (average M.W. 166, aromatic content less than 0.25 wt. %) available as Shell Sol OMS hydrocarbon solvent (Shell Chemical Co.). The weight ratio of ShellSol A100 to ShellSol OMS solvent is desirably at a 4:6 weight ratio. The ShellSol A100 solvent is a hydrocarbon mixture containing mostly aromatic hydrocarbons (over 90 wt % aromatic hydrocarbon), primarily C₉ to C₁₁ aromatic hydrocarbons. The ShellSol OMS solvent is a mixture of isoparaffin hydrocarbons (98 wt. % isoparaffins, M.W. about 166) with less than 0.25 wt % aromatic hydrocarbon content. The slurry formulation may be dispersed using a double planetary mixer. Dry powders (FeS₂ powder and carbon particles) are first blended to ensure uniformity before being added to the Kraton G1651 binder solution in the mixing bowl. The solvents are then added and the components blended in the mixer and until a homogeneous slurry mixture is obtained.

A preferred cathode wet slurry mixture is presented in Table 1:

TABLE I
Cathode Slurry

| | Wet Slurry |
|---|---|
| | (wt. %) |
| Binder | 2.0 |
| (Kraton G1651) | |
| Hydrocarbon Solvent | 13.4 |
| (ShellSol A100) | |
| (ShellSol OMS) | 20.2 |
| FeS₂ Powder | 58.9 |
| (Pyrox Red 325) | |
| Graphite | 4.8 |
| (Timrex KS6) | |
| Acetylene Carbon | 0.7 |
| Black (Super P) | |
| Total | 100.0 |

This same or similar wet cathode slurry mixture (electrolyte not yet added to the cell) is disclosed in commonly assigned application Ser. No. 11/516,534, filed Sep. 6, 2006. The total solids content of the wet cathode slurry mixture as shown in above Table 1 is 66.4 wt. %

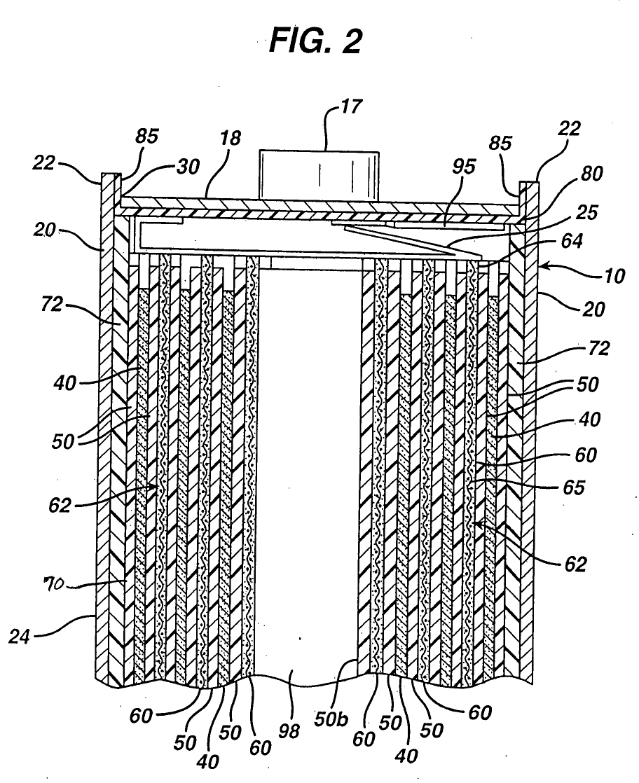

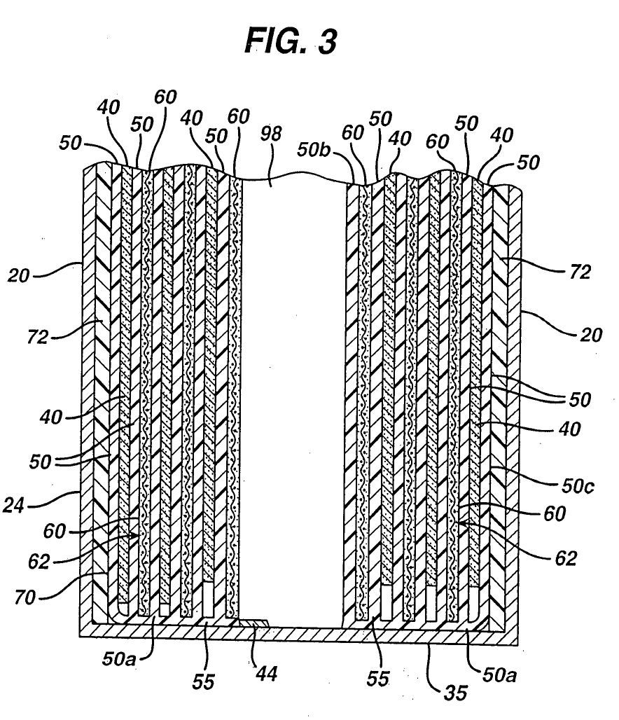

The cylindrical cell 10 may have a spirally wound electrode assembly 70 (FIG. 3) comprising anode sheet 40, cathode composite 62 with separator sheet 50 therebetween as shown in FIGS. 2-5. The Li/FeS₂ cell 10 internal configuration, apart from the difference in cathode composition, may be similar to the spirally wound configuration shown and described in U.S. Pat. No. 6,443,999. The anode sheet 40 as shown in the figures comprises lithium metal and the cathode sheet 60 comprises iron disulfide (FeS₂) commonly known as “pyrite”. The cell is preferably cylindrical as shown in the figures and may be of any size, for example, AAAA (42×8 mm), AAA (44×9 mm), AA (49×12 mm), C (49×25 mm) and D (58×32 mm) size. Thus, cell 10 depicted in FIG. 1 may also be a ⅔ A cell (35×15 mm) or other cylindrical size. However, it is not intended to limit the cell configuration to cylindrical shape. Alternatively, the cell of the invention may have a spirally wound electrode assembly formed of an anode comprising lithium metal and a cathode comprising iron disulfide (FeS₂) made as herein described inserted within a prismatic casing, for example, a rectangular cell having the overall shape of a cuboid. The Li/FeS₂ cell is not limited to a spirally wound configuration but the anode and cathode, for example, may be placed in stacked arrangement for use in coin cells.

For a spirally wound cell, a preferred shape of the cell casing (housing) 20 is cylindrical as shown in FIG. 1. Casing 20 is preferably formed of nickel plated steel. The cell casing 20 (FIG. 1) has a continuous cylindrical surface. The spiral wound electrode assembly 70 (FIG. 3) comprising anode 40 and cathode composite 62 with separator 50 therebetween can be prepared by spirally winding a flat electrode composite 13 (FIGS. 4 and 5). Cathode composite 62 comprises a layer of cathode 60 comprising iron disulfide (FeS₂) coated onto metallic substrate 65 (FIG. 4).

The electrode composite 13 (FIGS. 4 and 5) can be made in the following manner: In accordance with the method of the invention the cathode 60 comprising iron disulfide (FeS₂) powder dispersed therein can be initially prepared in the form of a wet slurry which is coated onto a side of conductive substrate sheet 65, preferably a sheet of aluminum or stainless steel which may a solid sheet with or without apertures therethrough, to form a cathode composite sheet 62 (FIG. 4). Conventional roll coating techniques may be used to coat the wet slurry onto a side of conductive substrate 65 (FIGS. 4 and 5). If an aluminum sheet 65 is used it may be a solid sheet of aluminum without openings therethrough or may be a sheet of expanded aluminum foil with openings therethrough thus forming a grid or screen.

The wet cathode slurry mixture having the composition shown above in Table 1 comprising iron disulfide (FeS₂), binder, conductive carbon and solvents is prepared by mixing the components shown in Table 1 until a homogeneous mixture is obtained.

The above quantities (Table 1) of components of course can be scaled proportionally so that small or large batches of cathode slurry can be prepared. The wet cathode slurry thus preferably has the following composition: FeS₂ powder (58.9 wt. %); Binder, Kraton G1651 (2 wt. %); Graphite, Timrex KS6 (4.8 wt %), Acetylene Black, Super P (0.7 wt %), Hydrocarbon Solvents, ShellSol A100 (13.4 wt %) and ShelSol OMS (20.2 wt %)

Applicants have tried to pretreat the FeS₂ powder by heating the powder in order to attempt reducing the amount of contaminants therein before the FeS₂ powder was used in forming the wet cathode slurry. It was found necessary to then place the treated FeS₂ in storage until ready for use in making the wet slurry as it is not practical in a commercial cell assembly operation to use the FeS₂ powder immediately after it has been pretreated. It has been discovered, however, that once the pretreated FeS₂ powder is thereafter stored or exposed to atmospheric conditions for even a short period prior to forming the wet slurry, much of the contaminants can reform in the powder. Such contaminants reform in the presence of moisture and oxygen in the atmosphere and result in components such as FeS, H₂S, H₂SO₄, H₂SO₃, FeSO₄, FeSO₄⁻nH₂O (hydrate). The contaminants, if present in the cathode, can significantly interfere with proper performance of the Li/FeS₂ cell. Some of the contaminants, which are acids or Fe containing salts, can react directly with cell components, for example, the aluminum conductive substrate 65 on which the cathode is coated or may react directly with the lithium metal anode 40. The acids or salt contaminants may also promote polymerization of certain electrolyte solvents and also may promote dissolution of the iron in the FeS contaminant. Iron from contaminants such as FeS or FeSO₄ may gradually dissolve in the electrolyte or diffuse through the electrolyte medium and deposit onto the surface of the lithium anode. Any of these reactions involving the contaminants can interfere with cell capability and impede performance.

It is thus important to develop a treatment method for processing the FeS₂ powder and/or cathode coating 60 that prevents any significant reformation of the contaminants prior to insertion of the cathode in the cell and during cell usage. Applicants have developed a method of FeS₂ cathode preparation which eliminates the need to preheat the FeS₂ powder prior to forming the wet cathode slurry. Instead Applicants can prepare the wet cathode slurry, for example, according to the formulation as given in Table 1 without preheating the FeS₂ powder. The FeS₂ powder (Pyrox Red 325) may be used directly as obtained from the supplier. The wet cathode slurry is formed (Table 1) and the wet slurry is then coated onto a side of the conductive substrate 65. The conductive substrate 65 with wet cathode slurry coated thereon is then dried in conventional convective oven as above indicated to evaporate the solvents in the slurry, thereby forming a dry cathode coating 60 on one side of conductive substrate 65 (FIGS. 4 and 5). The process is repeated, if desired, to also coat the opposite side of conductive substrate 65 with the wet cathode slurry (Table 1). The wet cathode slurry on the opposite side of conductive substrate 65 can then be subjected to drying in a convective oven to evaporate solvents, thereby forming a dry cathode coating 60 also on the opposite side of conductive substrate 65. The dry cathode coating 60 (whether applied to only one side or both sides of conductive substrate 65) is then subjected to calendering to compress the thickness of said dry cathode 60. At this point the dry cathode coating 60 on conductive substrate 65 is then subjected to the following step:

In accordance with the method of the invention, it has been determined that the dry cathode coating 60 on substrate 65 can be further subjected to baking in air under partial vacuum or in a nitrogen atmosphere (irrespective of pressure) at elevated temperature level between 250° C. and 375° C., preferably at a temperature between about 290° C. and 350° C., desirably at about 300° C. Tests by Applicants with Kraton G1651 polymeric binder reveal that the Kraton normally begins to lose its stability and rheological properties if heated in atmospheric air at a temperatures of about 250° C. Applicants, however, have determined that if such heat treatment of the dry cathode coating 60 on substrate 65 is done in air under partial vacuum or in nitrogen atmosphere (irrespective of pressure) the temperature stability of Kraton G1651 binder can be significantly extended to temperatures between about 250° C. and 375° C., preferably between about 290° C. and 350° C. and even up to a maximum of about 400° C. (Alternative heating atmosphere irrespective of pressure may be an inert atmosphere, such as argon, helium, neon, and krypton.)

Thus, it has been determined that if the dry cathode coating 60 on conductive substrate 65 is subjected to heating in air under partial vacuum or in nitrogen (or other inert atmosphere irrespective of pressure) the heating temperature (baking) can be extended to about 375° C. and even up to a maximum of about 400° C. without causing any significant deterioration in the Theological and physiochemical properties of the Kraton binder. In turn, it has been discovered that if the dry cathode coating 60 is subjected to such higher heating temperature (baking), the FeS₂ particles in the cathode can be purified of acids (H₂S, H₂SO₄ and H₂SO₃), and water therein to a very high degree. Moreover, if the heat treated (baked) cathode is then formed into an electrode spiral and inserted into the cell casing 20 and electrolyte added shortly thereafter, preferably in less than about 24 hours, since the time of the heat treatment (baking) of the cathode, the contaminants do not reform in any noticeable amount. That is, once the baked cathode is formed into a spiral and inserted in the cell casing 20 and electrolyte added, the cathode is not exposed to any moisture, since the electrolyte is moisture free. As a result there is no longer any environment present for the acidic contaminants to reproduce within or on the FeS₂ particles. Instead of inserting the cathode into the cell casing right after cathode baking or electrode assembly, the baked cathode 60 on substrate 65 or wound electrode assembly 70 can be stored for periods in sealed foil bags with nitrogen or other inert gas therein or in air under partial vacuum conditions prior to insertion into the cell casing. Alternatively, the wound electrode assembly 70 prior to or after insertion into the cell casing, may be stored in a dry room atmosphere having low relative humidity for a period up to about 24 hours. Electrolyte is then added to the cell covering the cathode with electrolyte as above indicated.

The cell containing cathode prepared by the method of the invention have reduced contents of water and acidic contaminants and thus exhibits improved performance and stability.

### Preparation of FeS₂ Test Cathode According to the Method of The Invention

A specific example of forming cathode 60 on substrate 65 employing the method of the invention is given as follows:

a) Prepare a cathode slurry mixture of FeS2 powder (Pyrox Red 325), acetylene black (Super P), graphite (Timrex KS6), and elastomeric binder Kraton G1651. Such cathode slurry mixture is preferably prepared by forming a binder/solvent mixture and separate mixture of FeS2 powder, acetylene black and graphite. The two mixtures may then be blended together and mixed to form a wet cathode slurry of composition as in Table 1. Mix the components in a planetary mixer until a homogeneous wet cathode slurry is obtained.

b) Coat the wet cathode slurry on one side of the conductive substrate 65, which may typically be sheet of aluminum or stainless steel.

c) Dry the wet cathode coating on substrate 65 in a convective oven (circulating hot air) to evaporate the solvents, thereby leaving a dry cathode coating 60 on substrate 65. The wet cathode slurry coated on the metal substrate 65 is dried in an oven preferably gradually adjusting or ramping up the temperature (to avoid cracking the coating) from an initial temperature of 40° C. to a final temperature not to exceed 130° C. for about ½ hour or until the solvent has substantially all evaporated. (At least about 95 percent by weight of the solvents are evaporated, preferably at least about 99.9 percent by weight of the solvents are evaporated.) This forms a dry or substantially dry cathode coating 60 comprising FeS₂, carbon particles, and binder on the metal substrate 65 and thus forms the cathode composite sheet 62 shown best in FIGS. 4 and 5.

d) Optionally, the opposite side of conductive substrate 65 may also be coated with the same wet slurry composition. In such case steps (a)-(c) are repeated.

e) Subject the conductive substrate 65 with dry cathode coating 60 thereon (cathode composite 62) to calendering to compress the thickness of the dry cathode coatings 60 on substrate 65.

f) Subject the conductive substrate 65 with dry cathode coating 60 thereon (cathode composite 62) to baking in a partial vacuum air atmosphere (pressure desirably less than 80 mm Hg absolute, preferably less than 50 mm Hg absolute). (Alternatively, the baking atmosphere, irrespective of pressure may be nitrogen, or inert gasses such as argon, neon, helium, or krypton.) The cathode coating 60 is subjected to baking at temperature desirably between about 250 and 375° C., preferably between about 290° C. and 350° C., for example at about 300° C. Cathode coating 60 on substrate 65 is subjected to baking at these temperature levels for a period typically between about 2 and 24 hours. Such baking may be extended for up to about 3 to 4 days. The baking of the cathode coating 60 at such elevated temperatures in the partial vacuum air atmosphere or in a nitrogen or inert gas atmosphere removes acids, water, and other contaminants from the FeS₂ particles and cathode coating 60.

g) After baking as in step (f) the cathode composite 62 (cathode coating 60 on substrate 65) is wound against a sheet of lithium anode 40 with separator 50 therebetween to form a wound electrode spiral assembly 70. A protective insulator film 72 may be applied around electrode spiral 70 and spiral 70 may then be inserted into casing 20. Electrolyte is added to the electrode spiral 70 in casing 20 as soon as possible, preferably within about 24 hours. The electrolyte contacts the anode and cathode material, thereby activating the cell. The presence of electrolyte also prevents air from penetrating into the anode or cathode material. As above indicated the baked cathode 60 on substrate 65 or wound electrode assembly 70 can be stored for periods in sealed foil bags with nitrogen or other inert gas therein or in atmosphere under partial vacuum conditions prior to insertion into the cell casing. Alternatively, the wound electrode assembly 70 prior to or after insertion into the cell casing, may be stored in a dry room atmosphere having low relative humidity for a period up to about 24 hours. Electrolyte is then added to the cell as soon as possible thereafter, to cover the cathode 60 therein.

### Preparation of Control FeS₂ Cathode

A control FeS₂ cathode is prepared in the following manner:

Before step (a) above pretreat the FeS₂ powder (Pyrox Red 325 from Chemetall GmbH) by subjecting the powder to heat treatment in an atmosphere of nitrogen at a temperature of about 250° C. to 300° C. for a period of between about 360 and 1440 minutes in attempt to remove acids and other contaminants from the FeS₂ powder. Return the pretreated FeS₂ back to storage in an inert atmosphere of nitrogen at room temperature (21° C.) for at least a few days. Perform all the above steps (a) to (g) as set forth in the preceding preparation of the Test Cathode except that the control cathode coating 60 is subjected to baking in step (f) in a partial vacuum (less than about 80 mm Hg) at a lower temperature, namely, in a range between 150° C. and 225° C.

For an AA size cell, the desired thickness of the final dry, calendered, cathode coating 60 is between about 0.172 and 0.188 mm, preferably about 0.176 mm. The dry cathode coating 60 thus may have the following desirable formulation: FeS₂ powder (89.0 wt. %); binder, Kraton G1651 elastomer (3.0 wt. %); conductive carbon particles, preferably graphite (7 wt. %) available as Timrex KS6 graphite from Timcal Ltd and conductive carbon black (1 wt %) available as Super P conductive acetylene black from Timcal, having a high BET surface of 62 m²/g. The carbon black tends to absorb electrolyte and develops a carbon network which improves conductivity. Optionally between about 0 and 90 percent by weight of the total carbon particles may be graphite. The graphite if added may be natural, synthetic or expanded graphite and mixtures thereof. The dry cathode coating may typically comprise between about 85 and 95 wt. % iron disulfide (FeS₂); between about 4 and 8 wt. % conductive carbon; and the remainder of said dry coating comprising binder material.

The cathode substrate 65 can be a sheet of conductive metal foil, for example, a sheet of aluminum or stainless steel, with or without apertures therein. The cathode conductive substrate 65 is preferably a sheet of aluminum. The aluminum sheet 65 may have a plurality of small apertures therein, thus forming a grid or screen. Such aluminum sheet is available as EXMET aluminum expanded foil from Dexmet Company. Alternatively, cathode conductive substrate 65 may be formed of a sheet of stainless steel expanded metal foil having a basis weight of about 0.024 g/cm² forming a mesh or screen with openings therein. The cathode conductive substrate 65 secures the cathode coating 60 and functions as a cathode current collector during cell discharge.

The anode 40 can be prepared from a solid sheet of lithium metal. The anode 40 is desirably formed of a continuous sheet of lithium metal (99.8% pure). Alternatively, the anode 40 can be an alloy of lithium and an alloy metal, for example, an alloy of lithium and aluminum. In such case the alloy metal, is present in very small quantity, preferably less than 1 or 2 percent by weight of the lithium alloy. (However, the amount of aluminum in the lithium alloy may be as high as about 5 percent by weight of the lithium alloy.) Upon cell discharge the lithium in the alloy thus functions electrochemically as pure lithium. Thus, the term “lithium or lithium metal” as used herein and in the claims is intended to include in its meaning such lithium alloy. The lithium sheet forming anode 40 does not require a substrate. The lithium anode 40 can be advantageously formed from an extruded sheet of lithium metal having a thickness of desirably between about 0.10 and 0.20 mm desirably between about 0.12 and 0.19 mm, preferably about 0.15 mm for the spirally wound cell.

Individual sheets of electrolyte permeable separator material 50, preferably of microporous polypropylene or polyethylene having a thickness of about 0.025 mm or less is inserted on each side of the lithium anode sheet 40 (FIGS. 4 and 5). The microporous polypropylene desirably has a pore size between about 0.001 and 5 micron. The first (top) separator sheet 50 (FIG. 4) can be designated the outer separator sheet and the second sheet 50 (FIG. 4) can be designated the inner separator sheet. The cathode composite sheet 62 comprising cathode coating 60 on conductive substrate 65 is then placed against the inner separator sheet 50 to form the flat electrode composite 13 shown in FIG. 4. The flat composite 13 (FIG. 4) is spirally wound to form electrode spiral assembly 70 (FIG. 3). The winding can be accomplished using a mandrel to grip an extended separator edge 50b (FIG. 4) of electrode composite 13 and then spirally winding composite 13 clockwise to form wound electrode assembly 70 (FIG. 3).

When the winding is completed separator portion 50b appears within the core 98 of the wound electrode assembly 70 as shown in FIGS. 2 and 3. By way of non limiting example, the bottom edges 50a of each revolution of the separator may be heat formed into a continuous membrane 55 as shown in FIG. 3 and taught in U.S. Pat. No. 6,443,999. As may be seen from FIG. 3 the electrode spiral 70 has separator material 50 between anode sheet 40 and cathode composite 62. The spirally wound electrode assembly 70 has a configuration (FIG. 3) conforming to the shape of the casing body. The spirally wound electrode assembly 70 is inserted into the open end 30 of casing 20. As wound, the outer layer of the electrode spiral 70 comprises separator material 50 shown in FIGS. 2 and 3. An additional insulating layer 72, for example, a plastic film such as polyester tape, can desirably be placed over a of the outer separator layer 50, before the electrode composite 13 is wound. In such case the spirally wound electrode 70 will have insulating layer 72 in contact with the inside surface of casing 20 (FIGS. 2 and 3) when the wound electrode composite is inserted into the casing. Alternatively, the inside surface of the casing 20 can be coated with electrically insulating material 72 before the wound electrode spiral 70 is inserted into the casing.

A nonaqueous electrolyte mixture can then be added to the wound electrode spiral 70 after it is inserted into the cell casing 20. The desired nonaqueous electrolyte comprises a lithium salt dissolved in an organic solvent. A desirable electrolyte solvent has been disclosed in commonly assigned application Ser. 11/516,534, filed Sep. 6, 2006. The desirable electrolyte solvent comprises methyl acetate (MA), propylene carbonate (PC), and ethylene carbonate (EC). Preferably the methyl acetate (MA) comprises between about 5 and 95 vol. %, propylene carbonate (PC) comprises between 1 and 94 vol %, and ethylene carbonate (EC) comprises between 1 and 50 vol % of the electrolyte solvent mixture. A desirable electrolyte for the Li/FeS₂ wound cell has been determined to comprise lithium salts lithium trifluoromethanesulfonate having the chemical formula LiCF₃SO₃ which can be referenced simply as LiTFS and/or the lithium salt Li(CF₃SO₂)₂N (LiTFSI) dissolved in an organic solvent mixture comprising methyl acetate (MA), propylene carbonate (PC), and ethylene carbonate (EC).

A suitable electrolyte has been determined to be an electrolyte solution comprising 0.8 molar (0.8 mol/liter) concentration of LiTFSI salt dissolved in an organic solvent mixture comprising about 75 vol. % methyl acetate (MA), 20 vol. % propylene carbonate (PC), and 5 vol. % ethylene carbonate (EC). Elemental iodine in the amount comprising about 0.5 wt % of the electrolyte is desirably added to the electrolyte. The electrolyte mixture is desirably added on the basis of about 0.4 gram electrolyte solution per gram FeS₂ for the spirally wound cell (FIG. 2).

An end cap 18 forming the cell's positive terminal 17 may have a metal tab 25 (cathode tab) which can be welded on one of its sides to inside surface of end cap 18. Metal tab 25 is preferably of aluminum or aluminum alloy. A portion of the cathode substrate 65 may be flared along its top edge forming an extended portion 64 extending from the top of the wound spiral as shown in FIG. 2. The flared cathode substrate portion 64 can be welded to the exposed side of metal tab 25 before the casing peripheral edge 22 is crimped around the end cap 18 with peripheral edge 85 of insulating disk 80 therebetween to close the cell's open end 30. End cap 18 desirably has a vent 19 which can contain a rupturable membrane designed to rupture and allow gas to escape if the gas pressure within the cell exceeds a predetermined level. Positive terminal 17 is desirably an integral portion of end cap 18. Alternatively, terminal 17 can be formed as the top of an end cap assembly of the type described in U.S. Pat. No. 5,879,832, which assembly can be inserted into an opening in the surface of end cap 18 and then welded thereto.

A metal tab 44 (anode tab), preferably of nickel can be pressed into a portion of the lithium metal anode 40. Anode tab 44 can be pressed into the lithium metal at any point within the spiral, for example, it can be pressed into the lithium metal at the outermost layer of the spiral as shown in FIG. 5. Anode tab 44 can be embossed on one side forming a plurality of raised portions on the side of the tab to be pressed into the lithium. The opposite side of tab 44 can be welded to the inside surface of the casing either to the inside surface of the casing side wall 24 or more preferably to the inside surface of close end 35 of casing 20 as shown in FIG. 3. It is preferable to weld anode tab 44 to the inside surface of the casing closed end 35, since this is readily accomplished by inserting an electrical spot welding probe (an elongated resistance welding electrode) into the cell core 98. Care should be taken to avoid contacting the welding probe to the separator starter tab 50b which is present along a portion of the outer boundary of cell core 98.

The primary lithium cell 10 may optionally also be provided with a PTC (positive thermal coefficient) device 95 located under the end cap 18 and connected in series between the cathode 60 and end cap 18 (FIG. 2). Such device protects the cell from discharge at a current drain higher than a predetermined level. Thus, if the cell is drained at an abnormally high current, e.g., higher than about 6 to 8 Amp, for a prolonged period, the resistance of the PTC device increases dramatically, thus shutting down the abnormally high drain. It will be appreciated that devices other than vent 19 and PTC device 95 may be employed to protect the cell from abusive use or discharge.

### Electrochemical Performance of Test Cells Employing FeS₂ Cathodes Prepared According to Method of the Invention Compared to Same Cells Employing Control FeS₂ Cathodes:

Test AA Cells and Control AA cells are made with same components and are identical in all respects except that the test cells have a cathode made by the method of the invention and the control cells are made by the protocol as above described. The electrolyte used in both test AA cells and the control AA cells comprised a mixture of Li(CF₃SO₂)₂N (LiTFSI) salt dissolved in a solvent mixture of 1,3 dioxolane (75 vol %) and sulfolane (25 vol %), as in commonly assigned U.S. patent application Ser. No. 11/494,244. Specifically, the test FeS₂ cathodes are made as described in the above protocol “Preparation Of FeS₂ Test Cathode According To The Method of The Invention”. Specifically, in the Test Cathodes, the dry cathode coating 60 on substrate 65 is subjected to baking in step (f) at an elevated temperature of about 300° C. in a vacuum air atmosphere (at pressure of less than about 50 mm Hg) or atmosphere of nitrogen for a period of about 360 minutes. The control FeS₂ cathodes were prepared as indicated in the above protocol “Preparation of Control FeS₂ Cathode.” Specifically, the control cathode 60 on substrate 65 was subjected to baking in step (f) in a partial vacuum air atmosphere at temperatures between about 150° C. to 225° C. for a period of about 720 minutes.

The Test AA cells and the Control AA cells were discharged to a cutoff voltage of about 1.05 Volts using a digital camera discharge test (Digicam test).

The digital camera test (Digicam test) consists of the following pulse test protocol wherein each test cell was drained by applying pulsed discharge cycles to the cell: Each cycle consists of both a 1.5 Watt pulse for 2 seconds followed immediately by a 0.65 Watt pulse for 28 seconds. This is repeated 10 times followed by 55 minutes rest. Then the cycling is repeated until the cutoff voltage is reached. (The first pulse mimics the power of the digital camera required to take a picture and the second pulse mimics the power to view the picture taken.) The cycles are continued until a cutoff voltage of 1.05V is reached. The number of cycles required to reach these cutoff voltages were recorded.

After the cells were filled, they were predischarged slightly to a depth of discharge of about 3 percent of the cell's capacity and then stored at room temperature for 14 days. The cells were then subjected to the above described Digicam test.

The test AA cells wherein the FeS₂ cathode was made by the method of the invention showed a 5 percent higher capacity (5 percent greater number of pulsed cycles) on the Digicam test than the above described control AA cells. Also resistance of the passivation layer buildup on the lithium anode surface was determined to be significantly lower for the test AA cells than the control AA cells. Namely, the added internal resistance of the cell due to passivation layer buildup on the lithium anode was determined to be 68 milliohm lower for the test cells compared to the control cells. Additionally tests which reflect degree of adhesion point to better adhesion (peel strength) of the test cathode 60 on substrate 65 compared to the control cathode 60 on substrate 65. The comparison tests were done using the a modified standard method for determining peel adhesion as set forth in ASTM D3330/D3330M-00. The better adhesion is attributed to the baking step (f) of the invention wherein the dry cathode 60 on substrate 65 is baked in partial vacuum air atmosphere or in nitrogen or inert gas atmosphere at elevated temperature of preferably about 300° C.

These benefits are realized by increasing the heating temperature (baking) of the dry cathode coating 60 on substrate 65 in step (f) above at a temperature between about 250 and 375° C., preferably between about 290° C. and 350° C., for example, at about 300° C. for a period of between about 120 and 1440 minutes. The baking may be done in a partial vacuum air atmosphere (less than 80 mm Hg absolute, preferably less than 50 mm Hg absolute) or in an atmosphere of nitrogen or inert gas such as argon, neon, helium or krypton (irrespective of pressure). It has been determined that the preferred binder Kraton G1651 does not significantly deteriorate when exposed to such elevated temperatures provided the cathode baking is carried out in said partial vacuum air atmosphere or atmosphere of nitrogen or inert gas. Acids, water, and other contaminants are thus removed from the FeS₂ powder during said baking step (f) to which the dry cathode coating 60 on substrate 65 is subjected. Since the cathode is inserted shortly thereafter into the cell casing and electrolyte then immediately added there is not much chance given for the contaminants to reform or reappear. The method of the invention thus makes it unnecessary to pretreat the FeS₂ powder as received from the supplier prior to forming the cathode slurry for coating substrate 65.

Although the invention has been described with reference to specific embodiments, it should be appreciated that other embodiments are possible without departing from the concept of the invention and are thus within the claims and equivalents thereof.

What is claimed is:

1. A method of preparing a cathode for a primary electrochemical cell wherein said cathode comprises iron disulfide (FeS₂) particles, comprising the steps of:
i) preparing a wet slurry mixture comprising iron disulfide (FeS₂) particles, carbon particles, polymeric binder, and liquid solvent;
ii) coating said slurry mixture onto at least one side of a substrate;
iii) drying said slurry mixture to evaporate said solvents forming a substantially dry coating comprising the iron disulfide particles, carbon particles, and polymeric binder on said substrate;
iv) baking said substantially dry coating in an atmosphere, wherein said atmosphere is selected from nitrogen, argon, neon, helium, krypton, and air under partial vacuum pressure, to remove acids and contaminants present in the iron disulfide particles and in said coating, and to form thereby a baked cathode coating on said substrate.

2. A method of preparing a cathode for a primary electrochemical cell wherein said cathode comprises iron disulfide (FeS₂) particles, comprising the steps of:
i) preparing a wet slurry mixture comprising iron disulfide (FeS₂) particles, carbon particles, polymeric binder, and liquid solvent;
ii) coating said slurry mixture onto at least one side of a substrate;
iii) drying said slurry mixture to evaporate said solvents forming a substantially dry coating comprising the iron disulfide particles, carbon particles, and polymeric binder on said substrate;
iv) baking said substantially dry coating in an atmosphere, wherein said atmosphere is air under partial vacuum pressure, to remove acids and contaminants present in the iron disulfide particles and in said coating, and to form thereby a baked cathode coating on said substrate.

3. The method of claim 2 wherein said atmosphere has a pressure of less than about 80 mm Hg absolute.

4. The method of claim 2 wherein said atmosphere has a pressure of less than about 50 mm Hg absolute.

5. The method of claim 2 wherein at least a substantial portion of said baking occurs at temperatures between about 250° C. and 375° C.

6. The method of claim 2 wherein at least a substantial portion of said baking occurs at temperatures between about 290° C. and 350° C.

7. The method of claim 2 wherein said binder comprises an elastomeric polymer.

8. The method of claim 2 wherein said binder comprises a styrene-ethylene/butylene-styrene (SEBS) block copolymer.

9. The method of claim 2 wherein the carbon particles comprise a mixture of acetylene black and graphite.

10. The method of claim 2 wherein said substrate is electrically conductive.

11. The method of claim 2 wherein said substrate comprises aluminum or stainless steel.

12. The method of claim 2 further comprising the steps of:
v) winding said baked cathode on said substrate against a sheet of lithium or lithium alloy, with separator sheet therebetween to form a wound electrode spiral;
vi) inserting said wound electrode spiral into a cylindrical casing; and
vii) adding electrolyte into said casing, thereby contacting said baked cathode with electrolyte.

13. The method of claim 5 wherein said baking is carried out for a period between about 2 hours and 4 days.

14. The method of claim 12 further comprising the step of storing the baked cathode in a partial vacuum atmosphere or in an inert atmosphere before electrolyte is added to the cell.

15. A method of preparing a cathode for a primary electrochemical cell wherein said cathode comprises iron disulfide (FeS₂) particles, comprising the steps of:
i) preparing a wet slurry mixture comprising iron disulfide (FeS₂) particles, carbon particles, polymeric binder, and liquid solvent;
ii) coating said slurry mixture onto at least one side of a substrate;
iii) drying said slurry mixture to evaporate said solvents forming a substantially dry coating comprising the iron disulfide particles, carbon particles, and polymeric binder on said substrate;
iv) baking said substantially dry coating in an atmosphere comprising a gas selected from the group consisting of nitrogen, argon, neon, helium, and krypton, and mixtures thereof, to remove water, acids and contaminants present in the iron disulfide particles and in said coating, and to form thereby a baked cathode coating on said substrate.

16. The method of claim 15 wherein at least a substantial portion of said baking occurs at temperatures between about 250° C. and 375° C.

17. The method of claim 15 wherein at least a substantial portion of said baking occurs at temperatures between about 290° C. and 350° C.

18. The method of claim 15 wherein said binder comprises an elastomeric polymer.

19. The method of claim 15 wherein said binder comprises a styrene-ethylene/butylene-styrene (SEBS) block copolymer.

20. The method of claim 15 wherein the carbon particles comprise a mixture of acetylene black and graphite.

21. The method of claim 15 wherein said substrate is electrically conductive.

22. The method of claim 15 wherein said substrate comprises aluminum or stainless steel.

23. The method of claim 15 further comprising the steps of:
v) winding said baked cathode on said substrate against a sheet of lithium or lithium alloy, with separator sheet therebetween to form a wound electrode spiral;
vi) inserting said wound electrode spiral into a cylindrical casing; and
vii) adding electrolyte into said casing, thereby contacting said baked cathode with electrolyte.

24. The method of claim 16 wherein said baking is carried out for a period between about 2 hours and 4 days.

25. The method of claim 23 further comprising the step of storing the baked cathode in a partial vacuum atmosphere or in an inert atmosphere before electrolyte is added to the cell.
